(19) United States
(12) Patent Application Publication
(10) Pub. No.: US 2016/0319929 A1
(43) Pub. Date: Nov. 3, 2016

(54) VEHICLE SHIFT CONTROL LEVER DEVICE

(71) Applicant: KYUNG CHANG INDUSTRIAL CO., Ltd., Daegu (KR)

(72) Inventor: DONG-WON KIM, Daegu (KR)

(21) Appl. No.: 15/132,551

(22) Filed: Apr. 19, 2016

(30) Foreign Application Priority Data
Apr. 30, 2015 (KR) 10-2015-0061221

(51) Int. Cl. F16H 59/02; F16H 59/04; F16H 59/10; F16H 61/22

(52) U.S. Cl. CPC F16H 59/0204; F16H 61/22; F16H 59/044; F16H 59/105

(57) ABSTRACT

A vehicle shift control lever device may be provided that includes: a transmission rod; a bearing guide which works together with a lower portion of the transmission rod and has an opening; and a motor assembly which is installed on one side of the bearing guide. The motor assembly includes: a motor; a first gear which is installed on a driving shaft of the motor and works together with the driving shaft of the motor; a second gear which is engaged with the first gear; a screw which is engaged with the second gear; and a nut which is mounted on the screw and comprises a detent pin.

### CROSS-REFERENCE TO RELATED APPLICATION

This application claims priority under 35 U.S.C. §119(a) to Republic of Korea Patent Application No. 10-2015-0061221 filed on Apr. 30, 2015, which is incorporated by reference herein in its entirety.

### BACKGROUND

1. Field

The present invention relates to a vehicle shift control lever device.

2. Description of the Related Art

In a vehicle equipped with a transmission, a lever device is provided which is located beside a driver's seat of the vehicle and allows the driver to select a shift mode. The lever device includes an electronic shift control lever device which electronically transmits an operation signal of the lever to a transmission control device.

A conventional electronic shift control lever device used to consist of a system having a structure capable of controlling shift positions by the operation of each of five solenoids when the driver changes the shift position. This conventional shift control lever device makes it possible for the driver to change the shift position under the condition such as a mechanical manner when changing the shift position.

However, since the conventional shift control lever device includes the solenoid, there have been problems of the weight increase, heat generation due to the overload of the solenoid, durability degradation, and noise generation.

### SUMMARY

One embodiment is a vehicle shift control lever device including: a transmission rod; a bearing guide which works together with a lower portion of the transmission rod and has an opening; and a motor assembly which is installed on one side of the bearing guide. The motor assembly includes: a motor; a first gear which is installed on a driving shaft of the motor and works together with the driving shaft of the motor; a second gear which is engaged with the first gear; a screw which is engaged with the second gear; and a nut which is mounted on the screw and includes a detent pin.

The motor assembly may further include a first sensor which senses a current position of the detent pin.

The first sensor may be a contact inductive sensor or a non-contact inductive sensor.

The vehicle shift control lever device may further include: a guide which includes a connection portion connected to the transmission rod, and a mover working together with the lower portion of the transmission rod; and a second sensor which is installed on the other side of the bearing guide and detects a movement of the mover.

The second sensor may be a hall sensor.

The transmission rod may further include an extension part which extends toward the guide and is connected to the connection portion.

The bearing guide may include an inner circumferential surface which defines the opening. A shift position change by the transmission rod may be mechanically restricted when the inner circumferential surface contacts the detent pin during the movement of the bearing guide.

The lower portion of the transmission rod may include a surface exposed by the opening. When the exposed surface contacts the detent pin, a shift position change by the transmission rod may be mechanically restricted.

The exposed surface may have an insertion recess into which the detent pin is inserted. When the detent pin is inserted into the insertion recess, the shift position change by the transmission rod may be allowed.

The vehicle shift control lever device may further include: a controller which determines the next position of the detent pin and generates a drive signal for driving the motor in accordance with the determined position of the detent pin; a first sensor which senses a current position of the detent pin; and a second sensor which senses a pivoting direction and the amount of pivoting of the transmission rod. The controller may determine the next position of the detent pin by considering the current position of the detent pin, which has been sensed by the first sensor, the pivoting direction and the amount of pivoting of the transmission rod, which have been sensed by the second sensor, on/off of a brake, on/off of an unlock button, and a traveling speed of the vehicle.

The opening may include a first opening which prevents an upper portion of the transmission rod from shifting forward and backward, and a second opening which prevents the upper portion of the transmission rod from shifting forward and enables the upper portion of the transmission rod to shift backward by maximum three steps. The detent pin may move from the first opening to the second opening or from the second opening to the first opening depending on at least one of the on/off of a brake, the on/off of an unlock button, and the traveling speed of the vehicle.

The opening may include a first opening which prevents an upper portion of the transmission rod from shifting forward and enables the upper portion of the transmission rod to shift backward by maximum one step, a second opening which prevents the upper portion of the transmission rod from shifting forward and enables the upper portion of the transmission rod to shift backward by maximum two steps, and a third opening which enables the upper portion of the transmission rod to shift forward by maximum one step and to shift backward by maximum two steps. The detent pin may move from any one of the first, second and third openings to one of the other openings depending on at least one of the on/off of a brake, the on/off of an unlock button, and the traveling speed of the vehicle.

The opening may include a first opening which prevents an upper portion of the transmission rod from shifting forward and enables the upper portion of the transmission rod to shift backward by maximum one step, and a second opening which enables the upper portion of the transmission rod to shift forward by maximum two steps and to shift backward by maximum one step. The detent pin may move from the first opening to the second opening or from the second opening to the first opening depending on at least one of the on/off of a brake, the on/off of an unlock button, and the traveling speed of the vehicle.

The opening may include a first opening which prevents an upper portion of the transmission rod from shifting backward and enables the upper portion of the transmission rod to shift forward by maximum one step, and a second opening which prevents the upper portion of the transmission rod from shifting backward and enables the upper portion of the transmission rod to shift forward by maximum three steps. The detent pin may move from the first opening to the second opening or from the second opening to the first opening depending on at least one of the on/off of a brake, the on/off of an unlock button, and the traveling speed of the vehicle.

The opening may include a first opening which prevents an upper portion of the transmission rod from shifting backward and enables the upper portion of the transmission rod to shift forward by maximum one step, and a second opening which prevents the upper portion of the transmission rod from shifting backward and enables the upper portion of the transmission rod to shift forward by maximum three steps. The detent pin may move from the first opening to the second opening or from the second opening to the first opening depending on at least one of the on/off of a brake, the on/off of an unlock button, and the traveling speed of the vehicle.

The opening may be comprised of a plurality of openings formed sequentially in a direction from an upper portion to a lower portion of the transmission rod. Each of the plurality of openings may have an arc shape about a shift rotation axis of the transmission rod.

### BRIEF DESCRIPTION OF THE DRAWINGS

FIG. 1 is a perspective view of a vehicle shift control lever device according to an embodiment of the present invention;

FIG. 2 is a right side view without external components for the purpose of showing an inner structure of the vehicle shift control lever device shown in FIG. 1;

FIG. 3 is a left side view without external components for the purpose of showing an inner structure of the vehicle shift control lever device shown in FIG. 1;

FIG. 4 is a rear view without external components for the purpose of showing an inner structure of the vehicle shift control lever device shown in FIG. 1;

FIG. 5 is a rear partial cross sectional view of a transmission rod, an elastically moving part and a groove member 40 shown in FIGS. 1 to 4;

FIG. 6 is a top view of the groove member shown in FIG. 5;

FIG. 7 is a right side view of the transmission rod and the elastically moving part shown in FIGS. 2 to 4;

FIG. 8 is a left side view of the transmission rod and the elastically moving part shown in FIGS. 2 to 4;

FIG. 9 is a right side view of the transmission rod shown in FIG. 7;

FIG. 10 is a top view of a guide 60 and a second sensor of the vehicle shift control lever device according to the embodiment;

FIGS. 11A to 11D show a motor assembly 100 of the vehicle shift control lever device according to the embodiment;

FIGS. 12A and 12B show an example for describing the operation of the motor assembly;

FIGS. 13A and 13B show another example for describing the operation of the motor assembly;

FIGS. 14 to 16 are rear cross sectional views of the transmission rod and a detent pin;

FIG. 17 is a table which shows that the position of the detent pin are determined at a P-shift position in accordance with a brake, an unlock button and whether driving or not, and shows whether the transmission rod is pivotable or not in accordance with the pivoting direction thereof;

FIG. 18 is a table which shows that the position of the detent pin are determined at an R-shift position in accordance with a brake, an unlock button and whether driving or not, and shows whether the transmission rod is pivotable or not in accordance with the pivoting direction thereof;

FIG. 19 is a table which shows that the position of the detent pin are determined at an N-shift position in accordance with a brake, an unlock button and whether driving or not, and shows whether the transmission rod is pivotable or not in accordance with the pivoting direction thereof;

FIG. 20 is a table which shows that the position of the detent pin are determined at a D-shift position in accordance with a brake, an unlock button and whether driving or not, and shows whether the transmission rod is pivotable or not in accordance with the pivoting direction thereof; and

FIG. 21 is a table which shows that the position of the detent pin are determined at an M-shift position in accordance with a brake, an unlock button and whether driving or not, and shows whether the transmission rod is pivotable or not in accordance with the pivoting direction thereof.

### DETAILED DESCRIPTION

An embodiment of the present invention will be described in detail with reference to the accompanying drawings. In the components of the present invention, detailed descriptions of what can be clearly understood and easily carried into practice through a prior art by those skilled in the art will be omitted to avoid making the subject matter of the present invention unclear.

### Embodiment

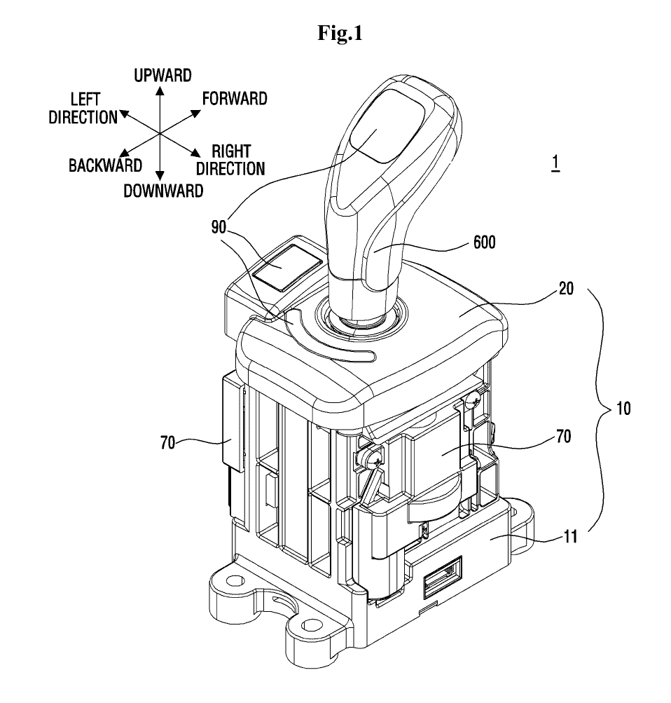

FIG. 1 is a perspective view of a vehicle shift control lever device 1 according to an embodiment of the present invention.

Referring to FIG. 1, the vehicle shift control lever device 1 according to the embodiment of the present invention may include a housing 10, a transmission rod 600, and a display device 90.

The housing 10 may include a base bracket 11, a side cover 70, and an upper cover 20.

The base bracket 11 allows the vehicle shift control lever device 1 to be installed within the vehicle.

The side cover 70 is disposed on the base bracket 11. The side cover 70 surrounds the sides of a lower portion 680 of the transmission rod 600, an elastically moving part 30, and a groove member 40, which are to be described below.

The upper cover 20 is disposed on the side cover 70 and is formed to expose a below-described transmission rod upper portion 670 to the outside.

The display device 90 displays a current shift position. The display device 90 may be disposed on the outer surface of the vehicle shift control lever device 1 so as to allow a driver to easily check the current shift position. For example, the display device 90 may be disposed on the outer surface of the upper cover 20 of the vehicle shift control lever device 1 and on the outer surface of the transmission rod upper portion 670.

The display device 90 may display the current shift position to the driver in a visual way such as characters, colors or the like. For example, for the purpose of allowing the driver to easily check the current shift position, the current shift position can be displayed on a display means like a liquid crystal by using alphabets P, R, N, D, M, etc. Also, the current shift position can be displayed on a display means like a liquid crystal by using a variety of colors. Specifically, the display device 90 may display the P, R, N, D, M-shift positions by white, red, green, yellow, blue colors respectively.

Here, although it has been described that the display device 90 displays in a visual way, the display device 90 is not limited to this and is able to display in various known methods.

The vehicle shift control lever device 1 according to the embodiment may further include a controller (not shown) which generates a drive signal. The controller may be included in the base bracket 11.

The vehicle shift control lever device 1 according to the embodiment may include a P-button (not shown). The P-button allows the driver of the vehicle to immediately change the current shift position to the P-shift position without using the transmission rod 600. Here, the P-button can be operated when the current shift position is the R, N or D-shift position. When the current shift position is the M-shift position, the P-button cannot be intended to operate.

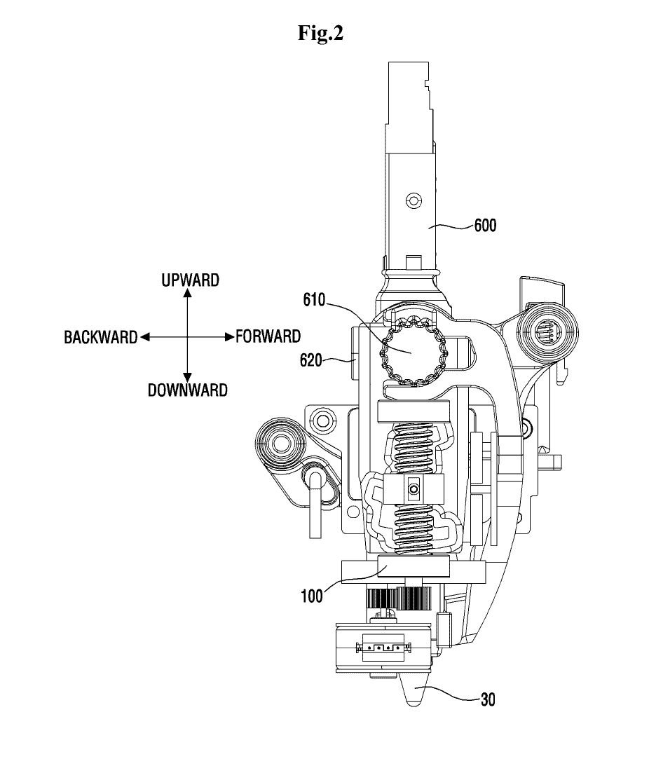

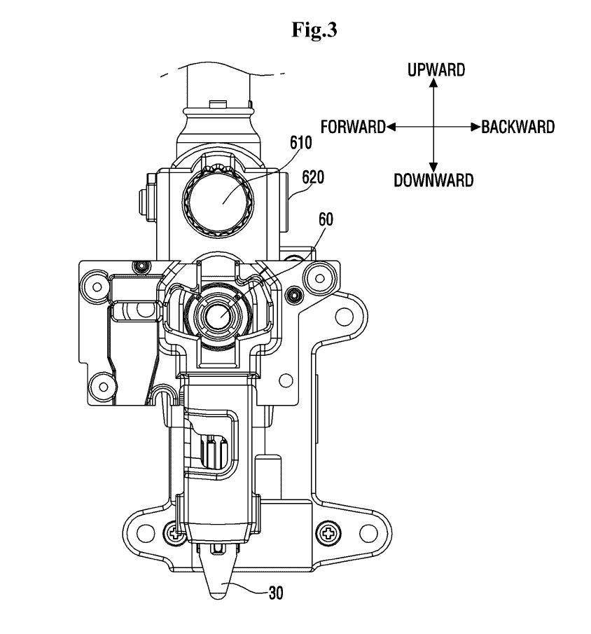

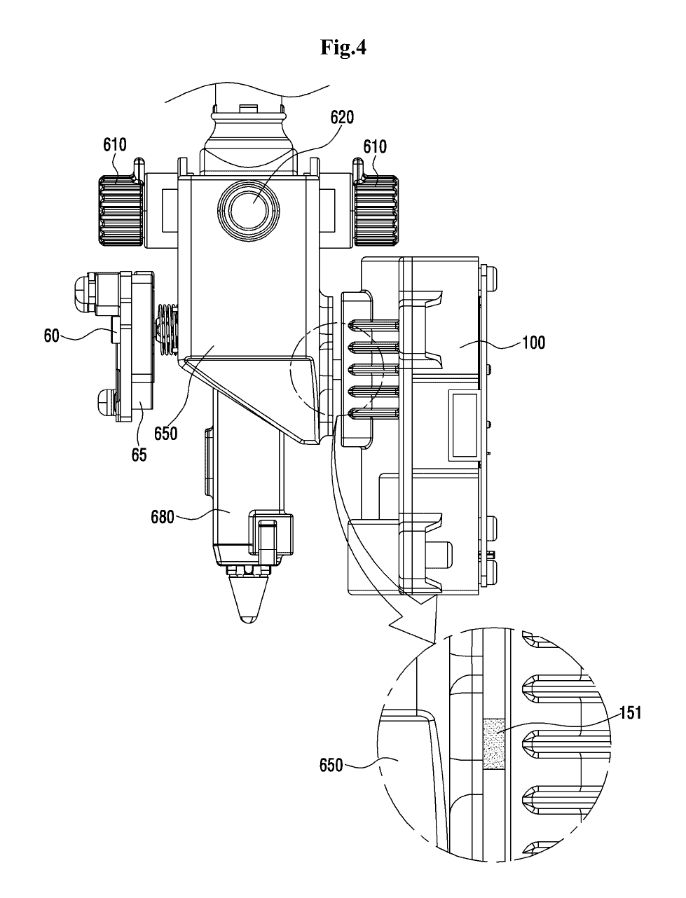

FIG. 2 is a right side view without external components for the purpose of showing an inner structure of the vehicle shift control lever device 1 shown in FIG. 1. FIG. 3 is a left side view without external components for the purpose of showing an inner structure of the vehicle shift control lever device 1 shown in FIG. 1. FIG. 4 is a rear view without external components for the purpose of showing an inner structure of the vehicle shift control lever device 1 shown in FIG. 1. Here, the external component may be the housing 10.

Referring to FIGS. 1 to 4, the transmission rod 600 may include a shift rotation axis 610 and a select rotation axis 620.

The transmission rod 600 may function to select the shift position. The transmission rod 600 can pivot within a certain range in a shift direction (forward and backward directions of the vehicle) about the shift rotation axis 610 or in a select direction (right and left directions of the vehicle) about the select rotation axis 620.

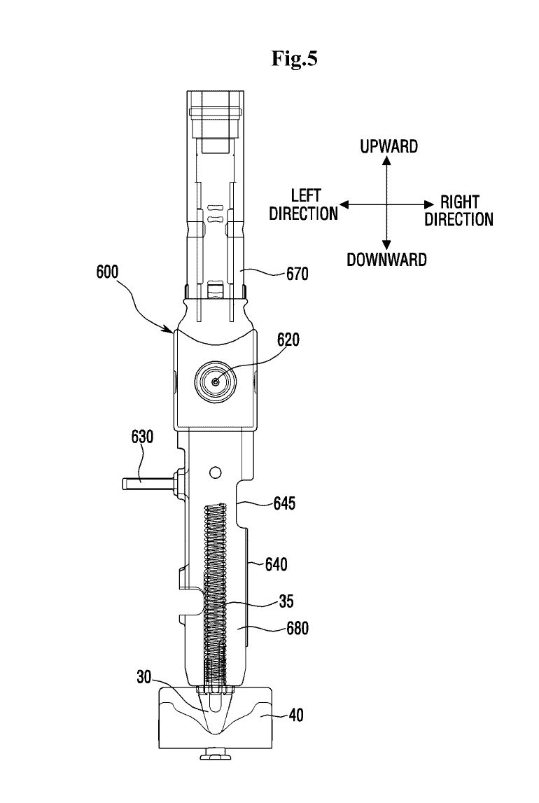

FIG. 5 is a rear partial cross sectional view of the transmission rod 600, the elastically moving part 30 and the groove member 40 shown in FIGS. 1 to 4.

Referring to FIGS. 1 to 5, the vehicle shift control lever device 1 may further include the elastically moving part 30 and the groove member 40 which are received in the housing 10.

The elastically moving part 30 is disposed under the transmission rod 600 in such a manner as to move in up-and-down and back-and-forth directions by an elastic member 35. The lower portion of the elastically moving part 30 is guided in contact with the groove member 40.

A groove which guides the elastically moving part 30 is formed on the top surface of the groove member 40. The groove which guides the elastically moving part 30 may have a concave shape.

The transmission rod 600 may further include an extension part 630, the transmission rod upper portion 670 located higher than the shift rotation axis 610 and the select rotation axis 620, and the transmission rod lower portion 680 located lower than the shift rotation axis 610 and the select rotation axis 620.

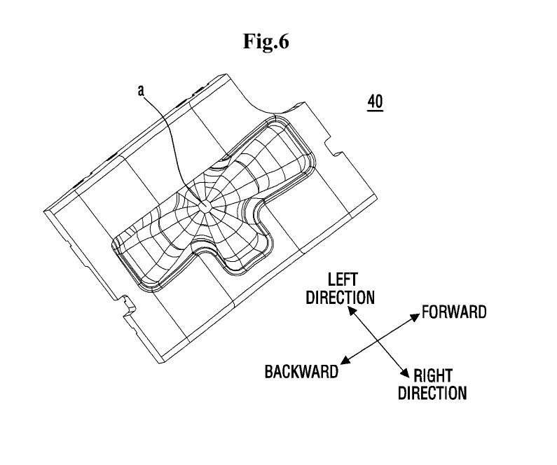

FIG. 6 is a top view of the groove member 40 shown in FIG. 5.

Referring to FIGS. 1 to 6, a stable position “a” is formed in the center of the groove of the groove member 40.

Inclined surfaces may be formed in the forward, backward, and right directions of the stable position “a”. The elastically moving part 30 moves along the inclined surface by the elastic member 35, and then returns to the stable position “a”.

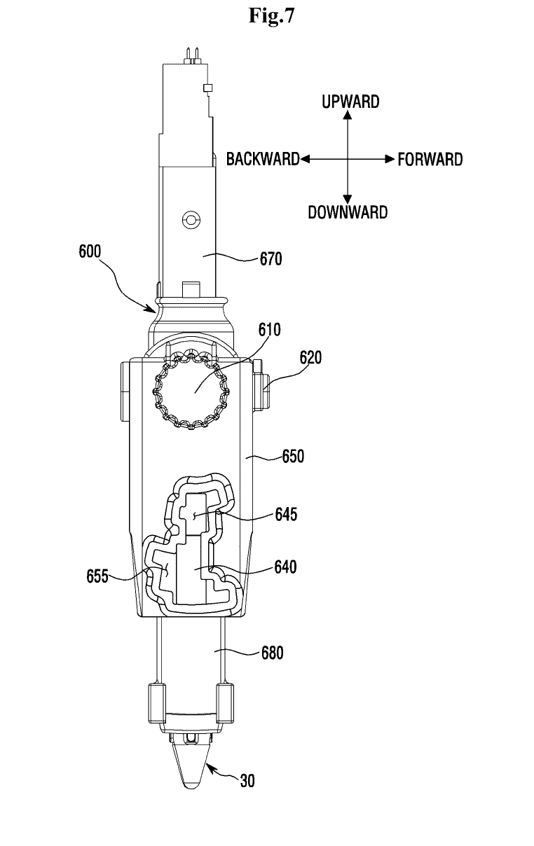

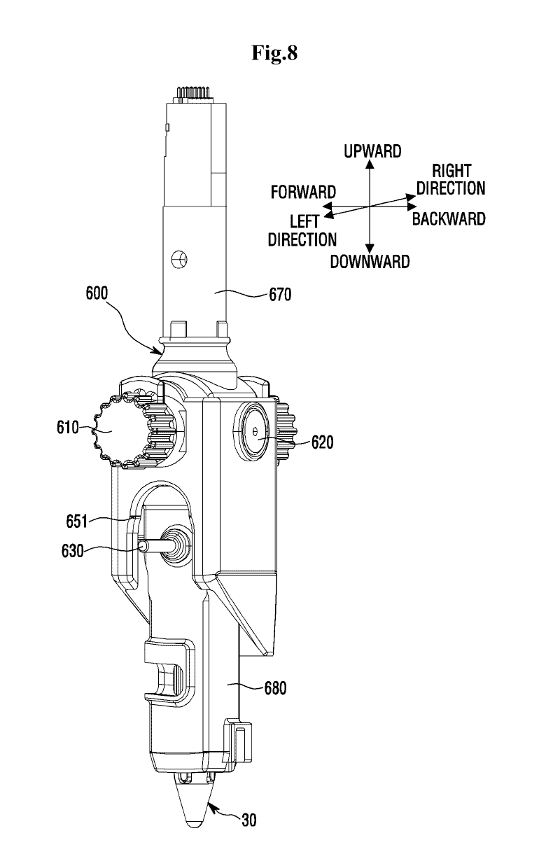

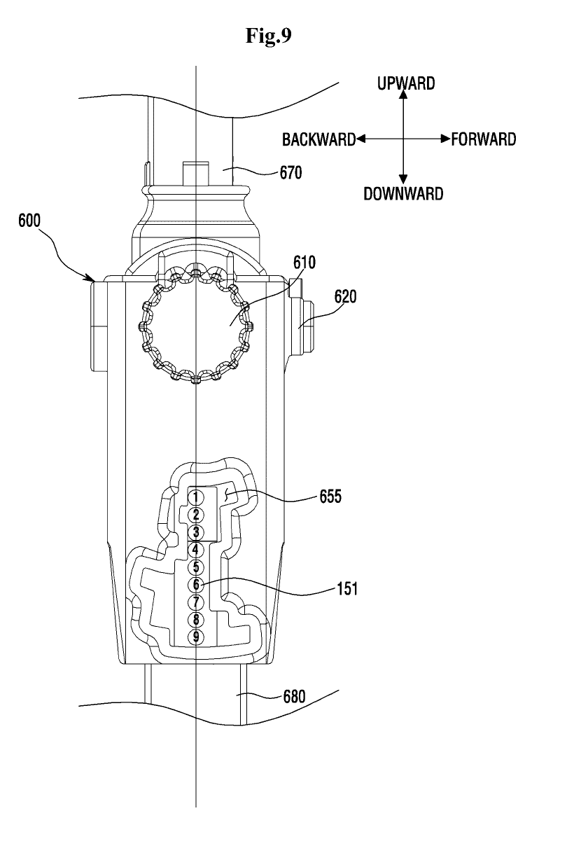

FIG. 7 is a right side view of the transmission rod 600 and the elastically moving part 30 shown in FIGS. 2 to 4. FIG. 8 is a left side view of the transmission rod 600 and the elastically moving part 30 shown in FIGS. 2 to 4. FIG. 9 is a right side view of the transmission rod 600 shown in FIG. 7.

Referring to FIGS. 1 to 9, the transmission rod 600 may further include a bearing guide 650. The bearing guide 650 surrounds at least a portion of the transmission rod lower portion 680, works together with the transmission rod lower portion 680, and has an opening 655.

An opening 651 may be formed in the left side of the bearing guide 650, and the extension part 630 may be located within the opening 651. The opening 655 may be formed in the right side of the bearing guide 650.

A detent pin 151 of a motor assembly 100 may be inserted into the opening 655 formed in the right side of the bearing guide 650.

A shift directional pivoting of the transmission rod 600 may be restricted by the detent pin 151 in accordance with the position of the detent pin 151. For example, the detent pin 151 may have a first to a ninth positions.

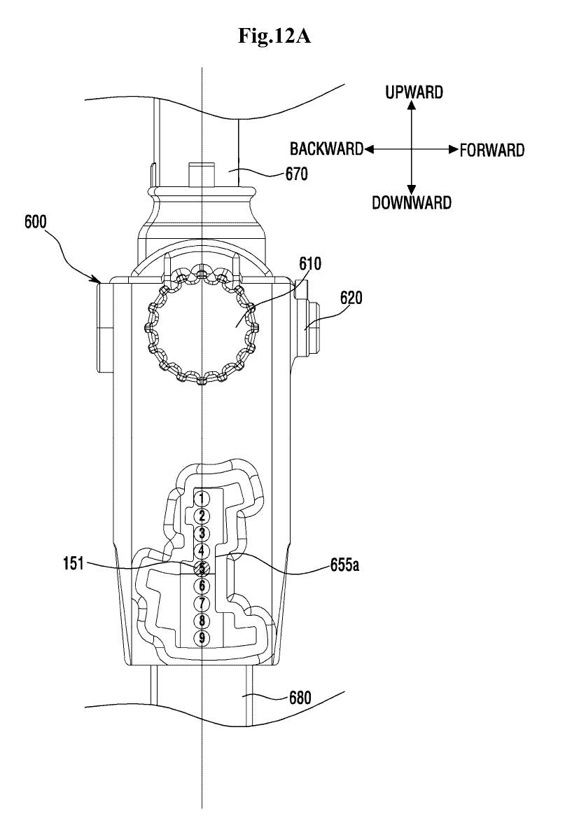

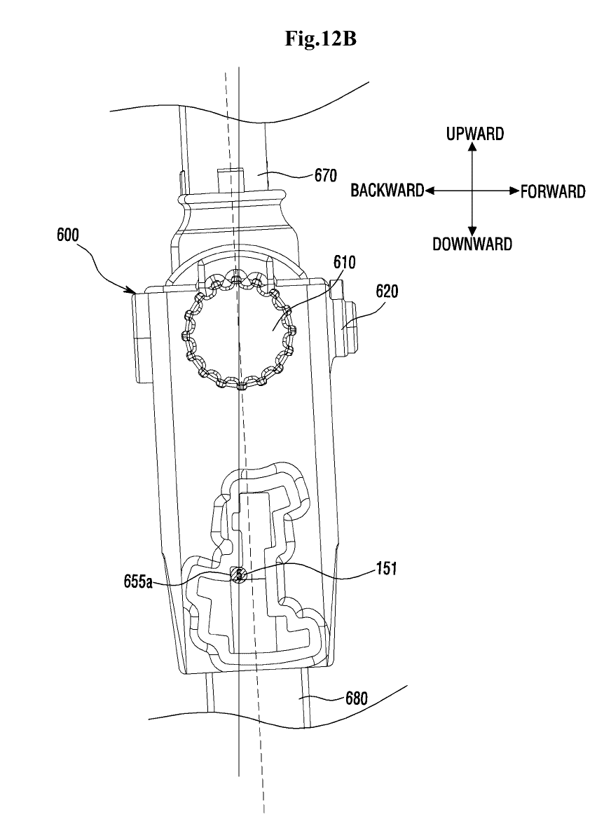

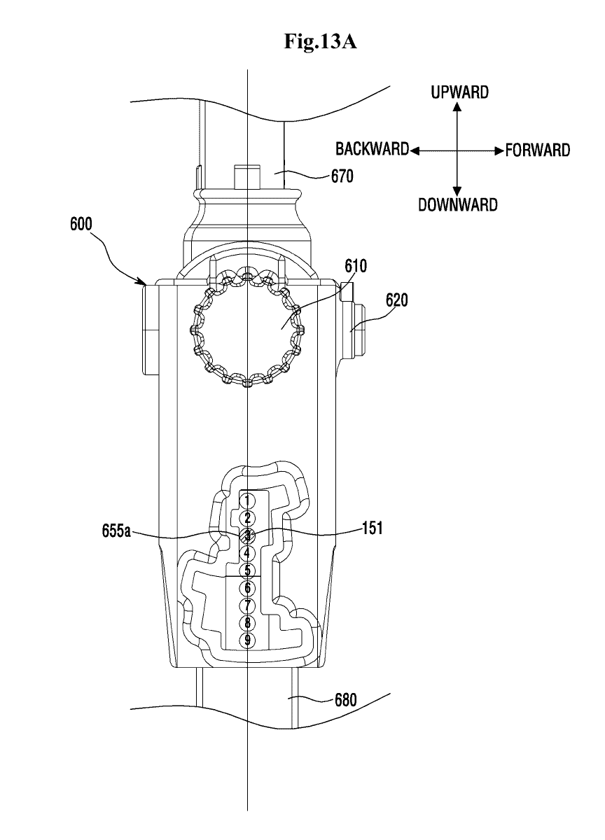

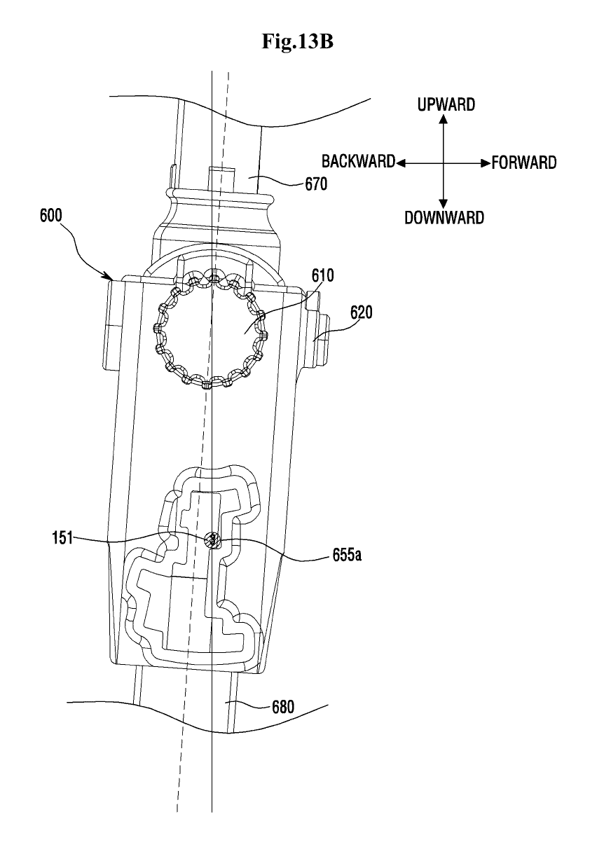

The bearing guide 650 may include, as shown in FIGS. 12 and 13, an inner circumferential surface 655a which defines the opening 655 such that the shift directional pivoting of the transmission rod 600 is restricted according to the first to ninth positions of the detent pin 151 of the motor assembly 100.

Also, the lower portion of the transmission rod 600 may include a surface 640 exposed by the opening 655. When the exposed surface 640 contacts the detent pin 151 in accordance with the fourth to ninth positions of the detent pin 151 of the motor assembly 100, the shift position change by a select directional pivoting of the transmission rod 600 may be mechanically restricted. Also, the exposed surface 640 has an insertion recess 645 into which the detent pin 151 is inserted. When the detent pin 151 is inserted into the insertion recess 645, the shift position change by the select directional pivoting of the transmission rod 600 is allowed.

Specifically, the opening 655 is comprised of a plurality of openings formed sequentially in a direction from the transmission rod upper portion 670 to the transmission rod lower portion 680. Each of the plurality of openings has an arc shape about the shift rotation axis 610 of the transmission rod 600.

For example, the opening 655 may include a first opening, a second opening, a third opening, a fourth opening, a fifth opening, a sixth opening, a seventh opening, an eighth opening, and a ninth opening, which are sequentially formed in the direction from the transmission rod upper portion 670 to the transmission rod lower portion 680 in correspondence to the first to ninth positions. Here, the detent pin 151 is movable upward or downward with respect to the fourth opening by the rotation of a screw 140.

The first opening has a space for receiving the detent pin 151, prevents the transmission rod upper portion 670 from shifting backward, and enables the transmission rod upper portion 670 to shift forward by maximum three steps. The detent pin 151 can move to the third opening from the first opening depending on at least one of the on/off of a brake, the on/off of an unlock button, and a traveling speed of the vehicle.

The second opening has a space for receiving the detent pin 151 and enables the transmission rod upper portion 670 to shift forward by one step and to shift backward by maximum one step. The detent pin 151 can move from the second opening to the third opening by the select directional pivoting of the transmission rod 600.

The third opening has a space for receiving the detent pin 151, prevents the transmission rod upper portion 670 from shifting backward, and enables the transmission rod upper portion 670 to shift forward by one step. The detent pin 151 can move to the first opening from the third opening depending on at least one of the on/off of a brake, the on/off of an unlock button, and a traveling speed of the vehicle. The detent pin 151 can move from the third opening to the second opening by the select directional pivoting of the transmission rod 600.

The fourth opening has a space for receiving the detent pin 151 and prevents the transmission rod upper portion 670 from shifting forward and backward. The detent pin 151 can move to the fourth opening from the sixth opening depending on at least one of the on/off of a brake, the on/off of an unlock button, and a traveling speed of the vehicle.

The fifth opening has a space for receiving the detent pin 151, prevents the transmission rod upper portion 670 from shifting forward, and enables the transmission rod upper portion 670 to shift backward by maximum one step. The detent pin 151 can move from the fifth opening to the seventh opening, from the fifth opening to the eighth opening, or from the fifth opening to the ninth opening depending on at least one of the on/off of a brake, the on/off of an unlock button, and a traveling speed of the vehicle.

The sixth opening has a space for receiving the detent pin 151, prevents the transmission rod upper portion 670 from shifting forward, and enables the transmission rod upper portion 670 to shift backward by maximum three steps. The detent pin 151 can move from the sixth opening to the fourth opening depending on at least one of the on/off of a brake, the on/off of an unlock button, and a traveling speed of the vehicle.

The seventh opening has a space for receiving the detent pin 151, prevents the transmission rod upper portion 670 from shifting forward, and enables the transmission rod upper portion 670 to shift backward by maximum two steps. The detent pin 151 can move from the seventh opening to the fifth opening or from the seventh opening to the eighth opening depending on at least one of the on/off of a brake, the on/off of an unlock button, and a traveling speed of the vehicle.

The eighth opening has a space for receiving the detent pin 151 and enables the transmission rod upper portion 670 to shift forward by maximum one step and to shift backward by maximum two steps. The detent pin 151 can move from the eighth opening to the fifth opening or from the eighth opening to the seventh opening depending on at least one of the on/off of a brake, the on/off of an unlock button, and a traveling speed of the vehicle.

The ninth opening has a space for receiving the detent pin 151 and enables the transmission rod upper portion 670 to shift forward by maximum two steps and to shift backward by maximum one step. The detent pin 151 can move from the ninth opening to the fifth opening depending on at least one of the on/off of a brake, the on/off of an unlock button, and a traveling speed of the vehicle.

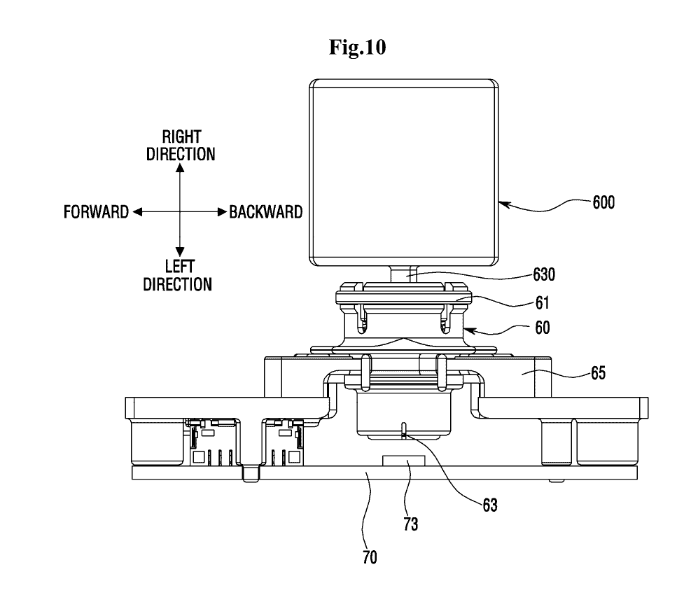

FIG. 10 is a top view of a guide 60 and a second sensor 73 of the vehicle shift control lever device 1 according to the embodiment.

Referring to FIGS. 1 to 10, the vehicle shift control lever device 1 may further include the guide 60 and the second sensor 73 which senses the pivoting direction and the amount of pivoting of the transmission rod 600.

The guide 60 includes a connection portion 61 which is connected to the transmission rod 600, and a mover 63 which works together with the lower portion of the transmission rod 600.

Also, the transmission rod 600 may further include the extension part 630 which extends toward the guide 60 and is connected to the connection portion 61.

The guide 60 moves in association with the shift directional pivoting and select directional pivoting of the transmission rod 600. Specifically, the guide 60 moves forward or backward in association with the shift directional pivoting of the transmission rod 600 and moves upward or downward in association with the select directional pivoting of the transmission rod 600.

Within the side cover 70, the second sensor 73 which detects the movement of the mover 63 is disposed in a position facing the mover 63. Here, the guide 60 has fixed directivity by a groove formed in a guide cover 65. That is, the guide 60 moves in a fixed direction along the path of the groove formed in the guide cover 65. Therefore, since the mover 63 moves in the fixed direction, the position of the mover 63 can be easily detected by the second sensor 73.

The mover 63 may be a magnet or a conductor. Here, when the mover 63 is a magnet, the second sensor 73 may be a 2D hall sensor of a 3D hall sensor. Also, when the mover 63 is a conductor, the second sensor 73 may be an inductive sensor.

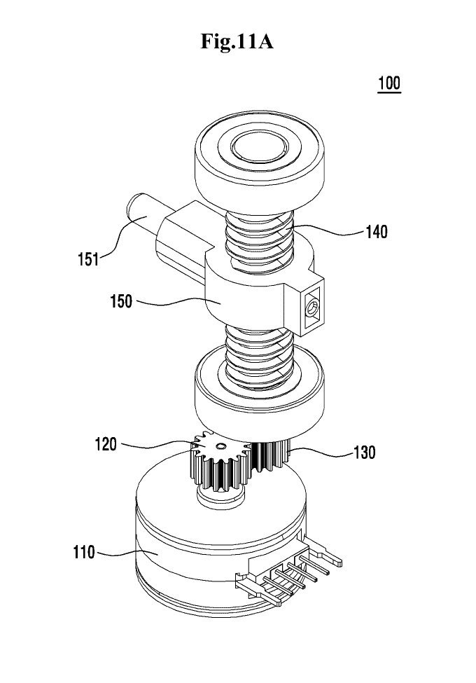

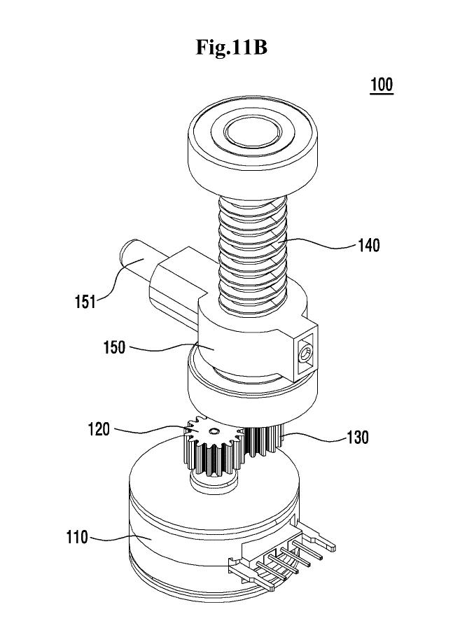

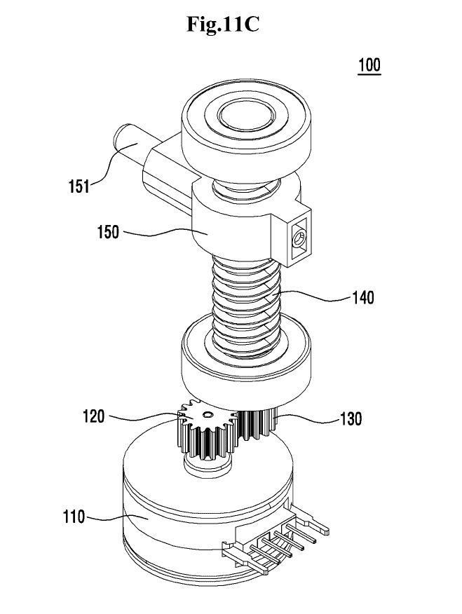

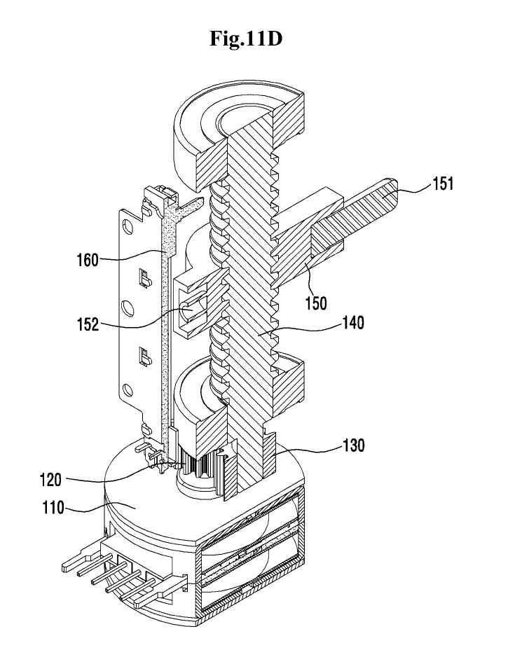

Hereinafter, the motor assembly 100 will be described with reference to FIGS. 11A to 11D.

FIGS. 11A to 11D show a motor assembly 100 of the vehicle shift control lever device 1 according to the embodiment.

Referring to FIGS. 1 to 11D, the vehicle shift control lever device 1 according to the embodiment of the present invention may further include the motor assembly 100.

The motor assembly 100 may be installed on one side of the bearing guide 650 and may include a motor 110, a first gear 120, a second gear 130, a screw 140, and a nut 150.

The motor 110 may rotate clockwise or counterclockwise in accordance with a signal received from a controller (not shown). The motor 110 includes a step motor.

The first gear 120 is installed on a driving shaft of the motor 110 and works together with the driving shaft. Here, the first gear 120 includes an idle gear.

The second gear 130 is engaged with the first gear 120. Here, the second gear 130 includes a pinion gear.

One end of the screw 140 is installed on the driving shaft of the second gear 130, and the screw 140 is engaged with the second gear 130. Here, although the second gear 130 and the screw 140 have been described to be formed as separate members, they are not limited to this. The second gear 130 and the screw 140 may be integrally formed with each other.

The nut 150 is mounted on the screw 140. The nut 150 can linearly reciprocate along the screw 140 by the rotation of the screw 140. The nut 150 includes the detent pin 151 located at the opening 655.

Also, the motor assembly 100 may further includes a first sensor 160. Here, the first sensor 160 is a position sensor and may be a contact inductive sensor or a non-contact inductive sensor.

The first sensor 160 senses the current position of the detent pin 151. For example, a conductor 152 may be disposed on the other end of the nut 150, and thus, the first sensor 160 can sense the current position of the detent pin 151. Here, if the current position of the detent pin 151, which has been detected by the first sensor 160, is not a predetermined position, the controller controls the motor 110 again, and thus, resets the position of the detent pin 151.

Here, since the nut 150 moves along the screw 140, the nut 150 may be, as shown in FIGS. 11B and 11C, located on both ends of the screw 140. Therefore, the first sensor 160 may be, as shown in FIG. 11D, formed to be equivalent to the length of the screw 140.

Hereinafter, the operations of the opening 655 and the detent pin 151 of the bearing guide 650 will be described.

The controller may determine the next position of the detent pin 151, and may control the motor 110 according to the determined next position of the detent pin 151.

The controller may determine the next position of the detent pin 151 by considering the current position of the detent pin 151, which has been sensed by the first sensor 160, the pivoting direction and the amount of pivoting of the transmission rod 600, which have been sensed by the second sensor 73, the on/off of a brake, the on/off of an unlock button, and a traveling speed of the vehicle.

The controller may generate a drive signal such that when an engine of the vehicle is turned off while the current shift position is the R, D or M-shift position, the current shift position is automatically changed to the P-shift position.

In a case where the current shift position of the traveling vehicle is shifted in a direction opposite to the traveling direction of the vehicle or is changed to the P-shift position, when the speed of the vehicle is less than 6 km/h, the controller controls the shift position to be changed, and when the speed of the vehicle is greater than 6 km/h, the controller controls the shift position to be changed to the N-shift position.

FIGS. 12A and 12B show an example for describing the operation of the motor assembly 100. FIGS. 13A and 13B show another example for describing the operation of the motor assembly 100. Specifically, FIGS. 12A, 12B, 13A and 13B are right side views of the transmission rod 600 shown in FIG. 6.

Referring to FIGS. 1 to 13B, the motor assembly 100 may restrict the shift directional pivoting of the transmission rod 600 in accordance with the shift position.

Specifically, the guide 60 is moved by the operation of the transmission rod 600, and the second sensor 73 detects the movement of the guide 60 and transmits the operational information of the transmission rod 600 to the controller. The controller which has received the operational information may set a new shift position by using the previous shift position and the operational information. Then, the motor 110 rotates clockwise or counterclockwise in accordance with the new shift position information received from the controller, and then may move the detent pin 151 to a position corresponding to the new shift position. Here, the controller may include a component mounted on a PCB.

For example, when the current shift position is the R-shift position, the detent pin 151 restricts the transmission rod upper portion 670 from pivoting forward about the shift rotation axis 610. Specifically, as shown in FIG. 12A, when the shift position is changed to the R-shift position, the detent pin 151 of the motor assembly 100 moves to the fifth position. When the detent pin 151 moves to the fifth position, the front side of the detent pin 151 contacts the inner circumferential surface 655a of the opening 655. Accordingly, the backward pivoting of the transmission rod lower portion 680, in other words, the forward pivoting of the transmission rod upper portion 670 is mechanically restricted, and the backward pivoting of the transmission rod upper portion 670 is allowed, so that the shift position can be changed from the R-shift position to N-shift position.

Here, when a predetermined condition is satisfied in the state where the shift position is the R-shift position, the detent pin 151 of the motor assembly 100 moves to the seventh position. When the detent pin 151 moves to the seventh position, the forward pivoting of the transmission rod upper portion 670 is restricted, and more backward pivoting of the transmission rod upper portion 670 is allowed than that at the fifth position, so that the shift position can be changed from the R-shift position to D-shift position at a time. Therefore, only when the predetermined condition is satisfied, the shift position can be changed from the R-shift position to D-shift position at a time.

Similarly, when the current shift position is the N-shift position, the detent pin 151 restricts the transmission rod upper portion 670 from pivoting forward about the shift rotation axis 610. Specifically, when the shift position is changed to the N-shift position, the detent pin 151 of the motor assembly 100 moves to the fifth position. When the detent pin 151 moves to the fifth position, the forward pivoting of the transmission rod upper portion 670 is restricted, and thus, the shift position cannot be changed from the N-shift position to R-shift position, and the backward pivoting of the transmission rod upper portion 670 is allowed. Therefore, the shift position can be changed from the N-shift position to D-shift position.

Here, when a predetermined condition is satisfied in the state where the shift position is the N-shift position, the detent pin 151 of the motor assembly 100 moves to the ninth position. When the detent pin 151 moves to the ninth position, both the forward and backward pivoting of the transmission rod upper portion 670 are allowed, so that the shift position can be changed from the N-shift position to R-shift position or D-shift position. Therefore, only when the predetermined condition is satisfied, the shift position can be changed from the N-shift position to R-shift position.

The backward pivoting of the transmission rod upper portion 670 is always allowed at the N-shift position. However, when the shift position is changed from the N-shift position to D-shift position in a state where the vehicle travels backward at a speed greater than a below-described safe shift possible speed, it is impossible to safely change the shift position. Therefore, when the vehicle travels backward at a speed greater than the safe shift possible speed, it is possible to prevent the shift position from being changed from the N-shift position to D-shift position by software even though the transmission rod upper portion 670 is pivoted backward.

Also, when the current shift position is the D-shift position, the detent pin 151 restricts the transmission rod upper portion 670 from pivoting backward about the shift rotation axis 610. Specifically, as shown in FIG. 13A, when the shift position is changed to the D-shift position, the detent pin 151 of the motor assembly 100 moves to the third position. When the detent pin 151 moves to the third position, the rear side of the detent pin 151 contacts the inner circumferential surface 655a of the opening 655. Accordingly, the forward pivoting of the transmission rod lower portion 680, in other words, the backward pivoting of the transmission rod upper portion 670 is restricted, and the forward pivoting of the transmission rod upper portion 670 is allowed, so that the shift position can be changed from the D-shift position to N-shift position.

Here, when a predetermined condition is satisfied in the state where the shift position is the D-shift position, the detent pin 151 of the motor assembly 100 moves to the first position. When the detent pin 151 moves to the first position, the backward pivoting of the transmission rod upper portion 670 is restricted, and more forward pivoting of the transmission rod upper portion 670 is allowed than that at the third position, so that the shift position can be changed from the D-shift position to R-shift position at a time. Therefore, only when the predetermined condition is satisfied, the shift position can be changed from the D-shift position to R-shift position at a time.

Also, for the purpose of changing the shift position to the P-shift position in the state where the shift position is the R, D or N-shift position, when the transmission rod upper portion 670 is pivoted forward in a state where a predetermined condition is satisfied, the detent pin 151 of the motor assembly 100 moves to the fourth position. When the detent pin 151 moves to the fourth position, the forward and backward pivoting of the transmission rod upper portion 670 is restricted.

Also, when the shift position is changed to the M-shift position, the detent pin 151 of the motor assembly 100 moves to the second position. When the detent pin 151 moves to the second position, both the forward and backward pivoting of the transmission rod upper portion 670 are allowed and the shift position can be manually changed to an upper or lower shift position.

Here, the predetermined condition allows the shift position to be changed to the R or P-shift position, changed from the R-shift position to D-shift position, or changed from the D-shift position to R-shift position. In order to prevent the driver from unintentionally changing the shift position and from changing the shift position during driving at a high speed making it impossible to safely change the shift position and in order to enable the driver to intentionally change the shift position and to change the shift position only during driving at a speed making it possible to safely change the shift position, the predetermined condition may be that brake and unlock buttons are in an on-state and the speed of the vehicle is the safe shift possible speed. The safe shift possible speed means a speed allowing the driver to safely change the shift position when the vehicle is in a stationary state or is driven at a very low speed. The safe shift possible speed may be less than 6 km/h, including the forward and backward driving of the vehicle.

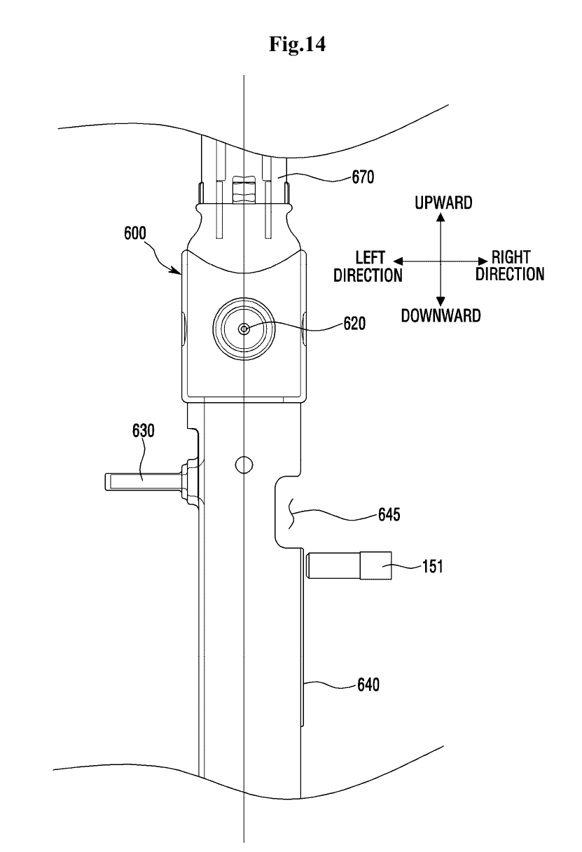

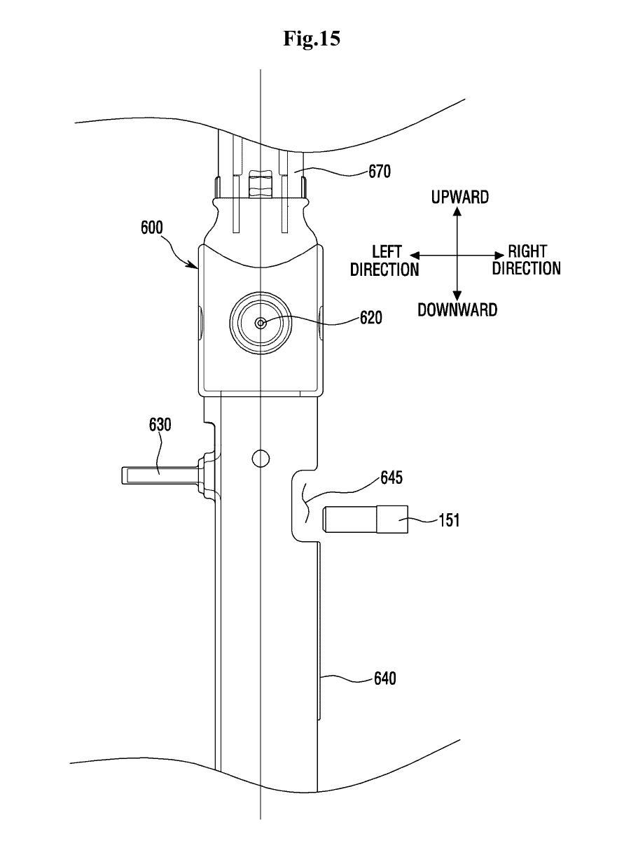

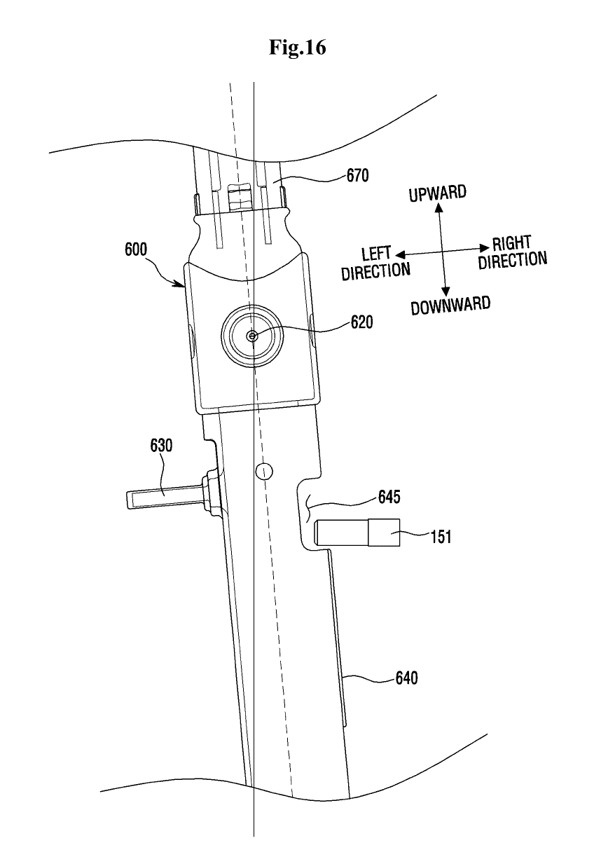

FIGS. 14 to 16 are rear cross sectional views of the transmission rod 600 and the detent pin 151. Specifically, FIG. 14 shows the detent pin 151 located at the fourth position. FIG. 15 shows the detent pin 151 located at the third position. FIG. 16 shows the transmission rod upper portion 670 of FIG. 15, which is pivoted to the left.

The motor assembly 100 may restrict the select directional pivoting of the transmission rod 600 in accordance with the shift position. For example, when the shift position is changed to the R or N-shift position, the detent pin 151 of the motor assembly 100 moves to one of the fifth and seventh to ninth positions, so that the detent pin 151 restricts the left direction pivoting of the transmission rod upper portion 670.

Meanwhile, the motor assembly 100 may allow the transmission rod 600 to pivot in the select direction in accordance with the shift position. For example, when the shift position is changed to the D or M-shift position, the detent pin 151 of the motor assembly 100 moves to the first to third positions, so that the transmission rod upper portion 670 may be pivoted to the left.

Specifically, as shown in FIG. 14, when the detent pin 151 is located at the fourth position, the end of the detent pin 151 contacts the inner circumferential surface 655a of the transmission rod 600, so that the motor assembly 100 is able to restrict the left direction pivoting of the transmission rod upper portion 670. Similarly, when the detent pin 151 is located at one of the fifth to ninth positions, the end of the detent pin 151 contacts the exposed surface 640 of the transmission rod 600, so that the motor assembly 100 is able to restrict the left direction pivoting of the transmission rod upper portion 670. As a result, the shift position cannot be changed from the R or N-shift position to M-shift position.

Meanwhile, when the detent pin 151 is, as shown in FIG. 15, located at the third position, even if the transmission rod upper portion 670 is, as shown in FIG. 16, pivoted to the left, the end of the detent pin 151 is inserted into the insertion recess 645 without contacting the exposed surface 640 of the transmission rod 600. Accordingly, the transmission rod upper portion 670 can be pivoted to the left. Similarly, when the detent pin 151 is located at the first or second position, the end of the detent pin 151 is inserted into the insertion recess 645 without contacting the exposed surface 640 of the transmission rod 600. Accordingly, the transmission rod upper portion 670 can be pivoted to the left, so that the shift position can be changed from the D-shift position to M-shift position or from the M-shift position to D-shift position.

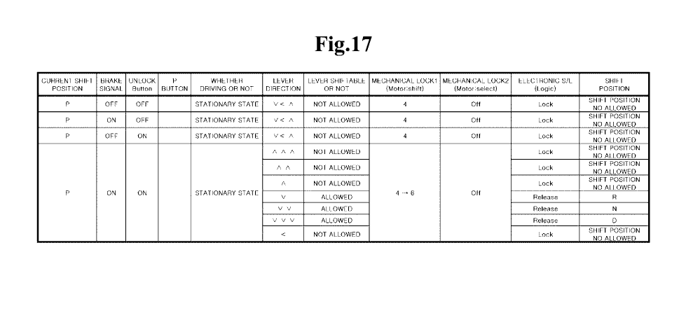

FIG. 17 is a table which shows that the position of the detent pin 151 are determined at the P-shift position in accordance with a brake, an unlock button and whether driving or not, and shows whether the transmission rod 600 is pivotable or not in accordance with the pivoting direction thereof.

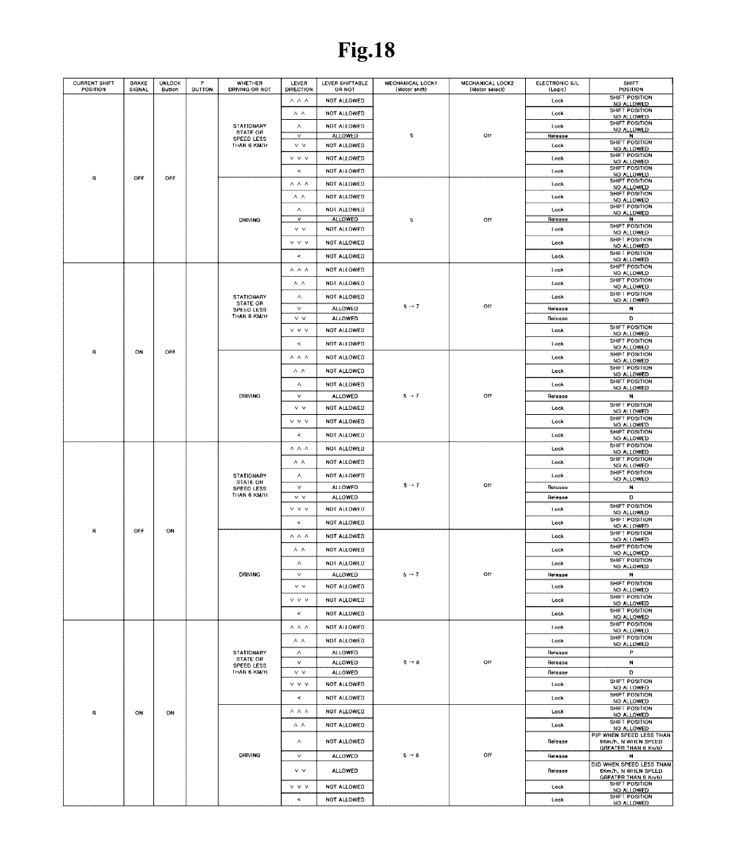

FIG. 18 is a table which shows that the position of the detent pin 151 are determined at the R-shift position in accordance with a brake, an unlock button and whether driving or not, and shows whether the transmission rod 600 is pivotable or not in accordance with the pivoting direction thereof.

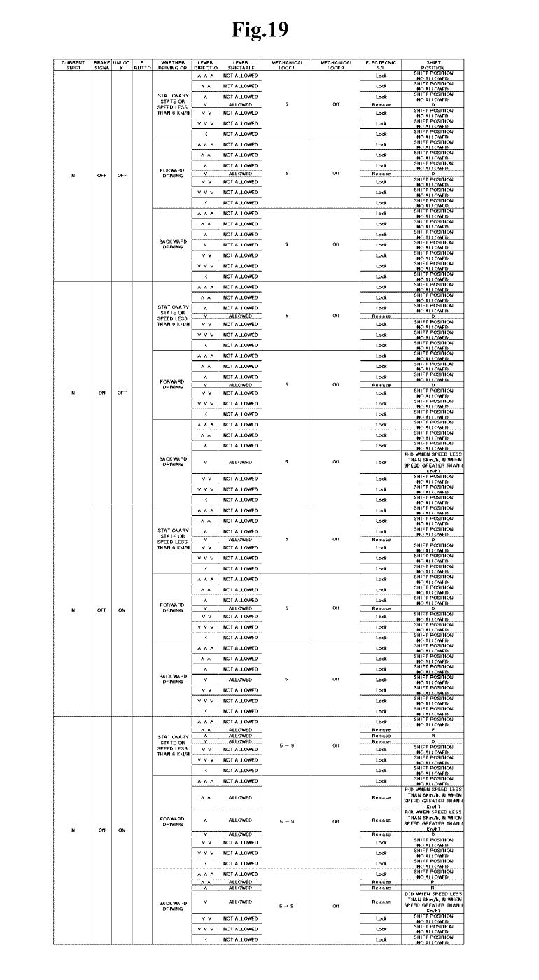

FIG. 19 is a table which shows that the position of the detent pin 151 are determined at the N-shift position in accordance with a brake, an unlock button and whether driving or not, and shows whether the transmission rod 600 is pivotable or not in accordance with the pivoting direction thereof.

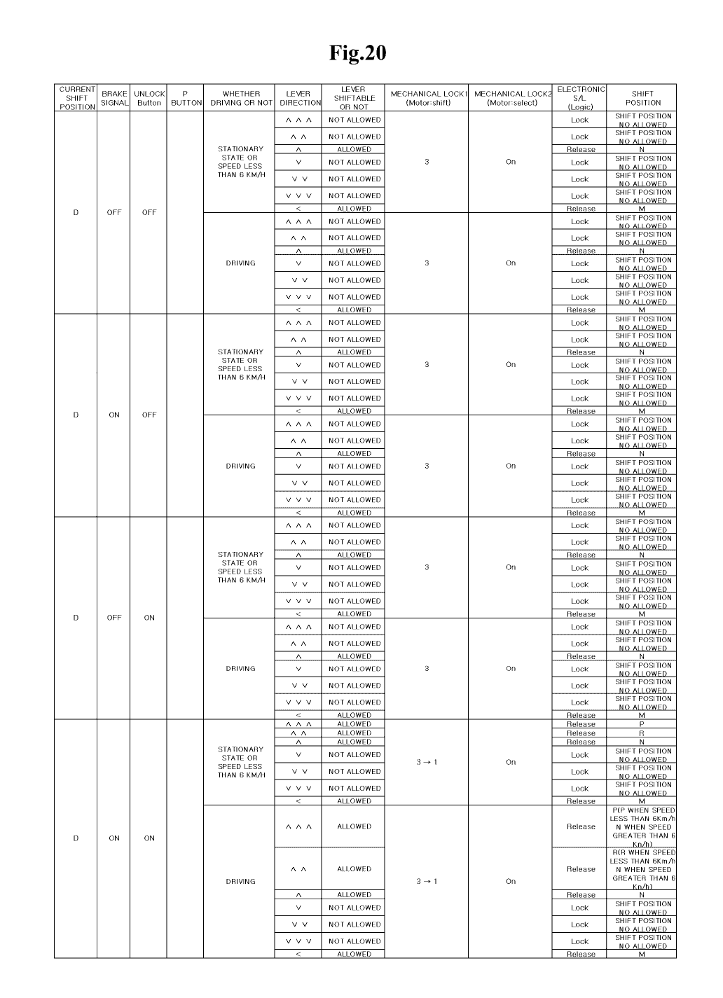

FIG. 20 is a table which shows that the position of the detent pin 151 are determined at the D-shift position in accordance with a brake, an unlock button and whether driving or not, and shows whether the transmission rod 600 is pivotable or not in accordance with the pivoting direction thereof.

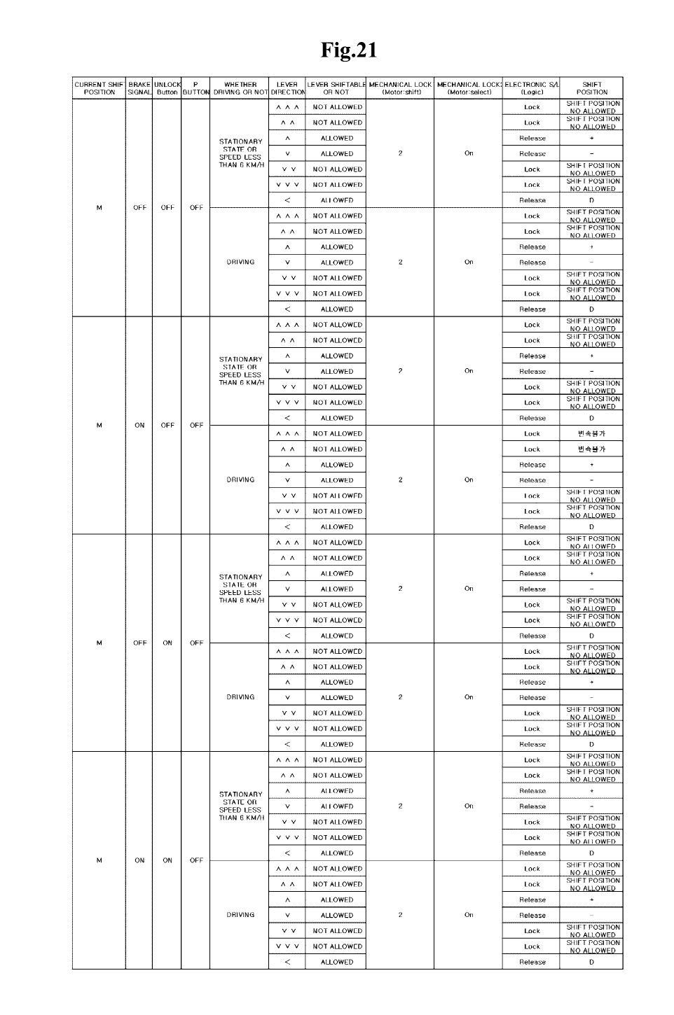

FIG. 21 is a table which shows that the position of the detent pin 151 are determined at the M-shift position in accordance with a brake, an unlock button and whether driving or not, and shows whether the transmission rod 600 is pivotable or not in accordance with the pivoting direction thereof.

Specifically, “ [symbol] ” shown in FIGS. 17 to 21 means that the transmission rod upper portion 670 is pivoted one step forward.

“ [symbol] [symbol] ” means that the transmission rod upper portion 670 is pivoted two steps forward.

“ [symbol] [symbol] [symbol] ” means that the transmission rod upper portion 670 is pivoted three steps forward.

“ [symbol] ” means that the transmission rod upper portion 670 is pivoted one step backward.

“ [symbol] [symbol] ” means that the transmission rod upper portion 670 is pivoted two steps backward.

“ [symbol] [symbol] [symbol] ” means that the transmission rod upper portion 670 is pivoted three steps backward.

“<” means that the transmission rod upper portion 670 is pivoted in the left direction.

The vehicle shift control lever device 1 according to the embodiment of the present invention changes, as shown in FIGS. 17 to 21, the position of the detent pin 151 in accordance with the brake, the unlock button and whether driving or not in order to restrict the pivoting direction of the transmission rod 600 at each shift position.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

What is claimed is:

1. A vehicle shift control lever device comprising:
a transmission rod;
a bearing guide which works together with a lower portion of the transmission rod 600 and has an opening; and
a motor assembly which is installed on one side of the bearing guide,
wherein the motor assembly comprises:
a motor;
a first gear which is installed on a driving shaft of the motor and works together with the driving shaft of the motor;
a second gear which is engaged with the first gear;
a screw which is engaged with the second gear; and
a nut which is mounted on the screw and comprises a detent pin.

2. The vehicle shift control lever device of claim 1, wherein the motor assembly further comprises a first sensor which senses a current position of the detent pin.

3. The vehicle shift control lever device of claim 1, wherein the first sensor is a contact inductive sensor or a non-contact inductive sensor.

4. The vehicle shift control lever device of claim 1, further comprising:
a guide which comprises a connection portion connected to the transmission rod, and a mover working together with the lower portion of the transmission rod; and
a second sensor which is installed on the other side of the bearing guide and detects a movement of the mover.

5. The vehicle shift control lever device of claim 4, wherein the second sensor is a hall sensor.

6. The vehicle shift control lever device of claim 4, wherein the transmission rod further comprises an extension part which extends toward the guide and is connected to the connection portion.

7. The vehicle shift control lever device of claim 1, wherein the bearing guide comprises an inner circumferential surface which defines the opening, and wherein a shift position change by the transmission rod is mechanically restricted when the inner circumferential surface contacts the detent pin during the movement of the bearing guide.

8. The vehicle shift control lever device of claim 1, wherein the lower portion of the transmission rod comprises a surface exposed by the opening, and wherein, when the exposed surface contacts the detent pin, a shift position change by the transmission rod is mechanically restricted.

9. The vehicle shift control lever device of claim 8, wherein the exposed surface has an insertion recess into which the detent pin is inserted, and wherein, when the detent pin is inserted into the insertion recess, the shift position change by the transmission rod is allowed.

10. The vehicle shift control lever device of claim 1, further comprising:
a controller which determines the next position of the detent pin and generates a drive signal for driving the motor in accordance with the determined position of the detent pin;
a first sensor which senses a current position of the detent pin; and
a second sensor which senses a pivoting direction and the amount of pivoting of the transmission rod,
wherein the controller determines the next position of the detent pin by considering the current position of the detent pin, which has been sensed by the first sensor, the pivoting direction and the amount of pivoting of the transmission rod, which have been sensed by the second sensor, on/off of a brake, on/off of an unlock button, and a traveling speed of the vehicle.

11. The vehicle shift control lever device of claim 10,
wherein the opening comprises a first opening which prevents an upper portion of the transmission rod from shifting forward and backward, and a second opening which prevents the upper portion of the transmission rod from shifting forward and enables the upper portion of the transmission rod to shift backward by maximum three steps,
and wherein the detent pin moves from the first opening to the second opening or from the second opening to the first opening depending on at least one of the on/off of a brake, the on/off of an unlock button, and the traveling speed of the vehicle.

12. The vehicle shift control lever device of claim 10,
wherein the opening comprises a first opening which prevents an upper portion of the transmission rod from shifting forward and enables the upper portion of the transmission rod to shift backward by maximum one step, a second opening which prevents the upper portion of the transmission rod from shifting forward and enables the upper portion of the transmission rod to shift backward by maximum two steps, and a third opening which enables the upper portion of the transmission rod to shift forward by maximum one step and to shift backward by maximum two steps,
and wherein the detent pin moves from any one of the first, second and third openings to one of the other openings depending on at least one of the on/off of a brake, the on/off of an unlock button, and the traveling speed of the vehicle.

13. The vehicle shift control lever device of claim 10,
wherein the opening comprises a first opening which prevents an upper portion of the transmission rod from shifting forward and enables the upper portion of the transmission rod to shift backward by maximum one step, and a second opening which enables the upper portion of the transmission rod to shift forward by maximum two steps and to shift backward by maximum one step,
and wherein the detent pin moves from the first opening to the second opening or from the second opening to the first opening depending on at least one of the on/off of a brake, the on/off of an unlock button, and the traveling speed of the vehicle.

14. The vehicle shift control lever device of claim 10,
wherein the opening comprises a first opening which prevents an upper portion of the transmission rod from shifting backward and enables the upper portion of the transmission rod to shift forward by maximum one step, and a second opening which prevents the upper portion of the transmission rod from shifting backward and enables the upper portion of the transmission rod to shift forward by maximum three steps,
and wherein the detent pin moves from the first opening to the second opening or from the second opening to the first opening depending on at least one of the on/off of a brake, the on/off of an unlock button, and the traveling speed of the vehicle.

15. The vehicle shift control lever device of claim 10,
wherein the opening comprises a first opening which prevents an upper portion of the transmission rod from shifting backward and enables the upper portion of the transmission rod to shift forward by maximum one step, and a second opening which enables the upper portion of the transmission rod to shift backward by maximum one step to shift forward by maximum one step,
and wherein the detent pin moves from the first opening to the second opening or from the second opening to the first opening depending on select directional pivoting of the transmission rod.

16. The vehicle shift control lever device of claim 1,
wherein the opening is comprised of a plurality of openings formed sequentially in a direction from an upper portion to a lower portion of the transmission rod,
and wherein each of the plurality of openings has an arc shape about a shift rotation axis of the transmission rod.
